(19) United States
(12) Patent Application Publication
(10) Pub. No.: US 2003/0041464 A1
(43) Pub. Date: Mar. 6, 2003

(54) Cordless knife having an interchangeable, rechargeable battery

(76) Inventor: Mark D. Anders, Arlington, TX (US)

Correspondence Address: Michael L. Diaz, Michael L. Diaz, P.C., Suite 200, 555 Republic Drive, Plano, TX, 75074, US

(21) Appl. No.: 09/943,602

(22) Filed: Aug. 30, 2001

(51) Int. Cl. B26B 15/00

(52) U.S. Cl. 30/277.4; 30/123.7; 30/142

(57) ABSTRACT

A cordless electric knife having a rechargeable battery pack interchangeable with other power tools. The cordless knife includes a main housing having a DC motor driving a plurality of pistons. The pistons move at least one blade in a cutting motion. The cordless knife also includes a heavy duty 12-volt battery pack which may be interchanged with other power tools.

### BACKGROUND OF THE INVENTION

1. Technical Field of the Invention

This invention relates to power utensils, and more particularly, to a cordless knife having an interchangeable, rechargeable battery.

2. Description of Related Art

Cordless knives have been around for many years. They provide cooks the ability to carve meat and poultry without much effort. Typically, existing cordless knives utilize rechargeable batteries having a very limited duty time between recharges. Additionally, the existing cordless kitchen knife is normally very light weight to allow for easy use by individuals within the kitchen. However, these existing kitchen cordless knives are very limited. The motor utilized is small, which prevents the use of larger, heavier knives. Larger, heavier-duty knives are preferred for use in outdoor activities. Therefore, although a cordless knife would be well received in outdoor activities, such as in fishing and hunting, existing cordless knives are not suitable for such outdoor activities.

Additionally, there are numerous cordless power tools which utilize rechargeable heavy-duty batteries. Typically, these rechargeable batteries may be interchanged with other power tools, eliminating the need for several batteries. In addition, it is much simpler to recharge one battery rather than a plurality of batteries to accommodate a plurality of power tools. However, these power tools, although numerous in type of power tool heads, do not include cutting utensils. Specifically, there are no power tools which include a powered knife. There are several cordless power saws, however, these saws are too bulky and cumbersome for use as a knife in hunting and fishing.

Although there are no known prior art teachings of a device such as that disclosed herein, prior art references that discuss subject matter that bears some relation to matters discussed herein are U.S. Pat. No. 3,952,239 to Owings et al. (Owings), U.S. Pat. No. 4,891,884 to Torbet (Torbet), U.S. Pat. No. 6,007,939 to Clowers (Clowers), and U.S. Pat. No. 6,176,017 to Sato et al. (Sato).

Owings discloses a modular cordless tool having several different electrical tools. The modular construction includes individual tool elements such as a motor and a driven saw blade or chuck as its output means. The individual tool heads include only those components which are individually tailored to the particular output required. The other basic modular section includes a power handle, a functional hand grip, a battery, a switch, and a switch operator means located for control by an operator with his hand in position on the hand grip. However, Owings does not teach or suggest the use of a knife powered by the interchangeable battery source.

Torbet discloses a lightweight hand holdable appliance having a plurality of blades for slicing, peeling and the like. The appliance is preferably cordless and rechargeable. The blade includes a knife having a thin single blade suitable for slicing and a peeler having a single peeling blade for peeling. However, Torbet does not teach or suggest the knife being powered by an interchangeable battery for use with other power tools. Torbet merely discloses the use of a conventional electric battery affixed within the housing of the cordless knife. Additionally, the knife disclosed in Torbet does not have a power source having the battery life or power to drive a knife suitable for outdoor activities.

Clowers discloses a battery pack having a housing adapted for connection to a cordless power tool. A plurality of lower battery cells are positioned within the housing and electrically connected in series with one another. An upper battery cell is stacked on a first of the lower battery cells and is electrically connected in series with the plurality of lower battery cells. Although Clowers discusses use of the battery pack with a variety of power tools, Clowers does not teach or suggest utilizing the battery pack with a heavy-duty cordless electric knife.

Sato discloses an electric kitchen knife having blades connected to a main housing. The blades move in a reciprocal motion to cut food. The main housing has a stand leg projecting from the bottom surface of the main housing. The stand leg maintains the main housing in an upright standing position. However, Sato does not teach or suggest a cordless knife powered by an interchangeable battery which may be used to power other power tools.

Review of the foregoing references reveals no disclosure or suggestion of a heavy-duty, cordless knife having an interchangeable battery pack adaptable for use with other power tools as that described and claimed herein. Thus, it would be a distinct advantage to have such an apparatus providing a cordless knife for use in outdoor activities, providing sufficient power to drive a heavy-duty blade and for an extended period of time prior to recharging. It is an object of the present invention to provide such an apparatus.

### SUMMARY OF THE INVENTION

In one aspect, the present invention is a cordless knife for use in cutting. The knife includes a main housing having a receiving chamber located on a first end of the main housing. At least one blade is positioned within a blade receptacle located at a second end opposite the first end of the main housing. The blade is detachably retained within the blade receptacle. The blade is driven in a reciprocal cutting motion. In addition, the cordless knife includes a rechargeable power source capable of being interchanged with other power tools. The power source is positioned within the receiving chamber of the main housing. A trigger is used to actuate the driving of the blade. When the trigger is depressed, the trigger allows the rechargeable power source to actuate the driving of the blade in a reciprocal cutting motion.

In another aspect, the present invention is a cordless knife for use in cutting. The knife includes a main housing having a receiving chamber located on a first end of the main housing. At least one blade is positioned within a blade receptacle located at a second end opposite the first end of the main housing. A retaining lever holds a portion of the blade within the blade receptacle. In addition, a motor is used for driving the blade in a reciprocal cutting motion. A rechargeable battery pack module capable of being interchanged with other power tools is positioned within the receiving chamber of the main housing. The cordless knife also includes a trigger for actuating the motor. By depressing the trigger, the battery pack module is then connected to the motor, which drives the blade in a reciprocal cutting motion.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a side view of a cordless knife in the preferred embodiment of the present invention;

FIG. 2 is a side perspective view of the battery pack removed from the main housing in the preferred embodiment of the present invention;

FIG. 3 is a side cutaway view of an interior portion of the main housing of FIG. 1;

FIG. 4 illustrates a side view of the outer surface of the main housing with the battery pack inserted within the receiving chamber in the preferred embodiment of the present invention;

FIG. 5 is a bottom longitudinal view of the outer surface of the main housing and battery pack of FIG. 4; and

FIG. 6 is a top longitudinal view of the outer surface of the main housing and battery pack of FIG. 4.

### DETAILED DESCRIPTION OF EMBODIMENTS

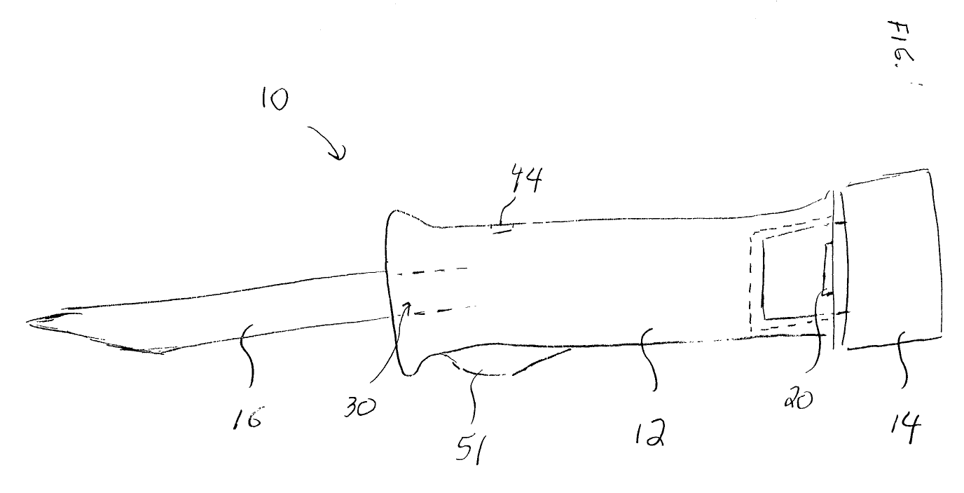

A heavy-duty cordless knife having an interchangeable battery pack for use with other power tools is disclosed. FIG. 1 is a side view of a cordless knife 10 in the preferred embodiment of the present invention. The knife includes a main housing 12, an interchangeable battery pack 14, and a blade 16. The main housing is preferably constructed of a durable rigid material such as a hard plastic shell casing. The hard plastic shell is waterproof preventing the inadvertent splashing of water upon the knife from damaging the interior of the knife.

The battery pack is preferably a 12-volt DC battery pack well known for use with rechargeable power tools. However, in alternate embodiments of the present invention, the battery pack may be of another voltage, such as 9 or 15 volts. The 12 volt DC battery pack is preferred because of its well known ability to keep a charge, run a power tool for a fairly lengthy time period, and the capability to drive a heavy duty power tool. The battery pack also includes a locking mechanism 20 which locks the battery pack to the main housing 12. In addition, the battery pack includes a release button 22 to disengage the locking mechanism when removing the battery pack from the main housing.

The blade 16 is preferably constructed of a resilient heavy duty steel such as stainless steel. However, any material which provides a rigid durable surface and can be constructed to maintain a sharp edge for cutting may be utilized. The blade is of sufficient length to allow ease of cutting of an object, such as a fish. Although only one blade is illustrated in FIG. 1, the knife 10 may include two or more blades utilizing the housing 12. In addition, the main housing may accommodate several different sizes and types of blades for use with different objects. For example, if an object is constructed of a thick hard surface, a more rugged serrated blade may be utilized. However, for more delicate and precise cutting (e.g., carving into a fish), a smaller, sharper blade may be necessary. Thus, the housing may accommodate a blade having a shank section 30 which is of a universal size to be accommodated within the housing.

The main housing also includes a blade receptacle 40 to accommodate the shank section 30 of the blade 16. The blade receptacle is a chamber large enough to allow the blade to move parallel to the longitudinal length of the main housing. During the cutting operation, the blade moves back and forth. Therefore, the blade receptacle must be of sufficient size to allow adequate space for the blade's movement. The main housing holds the blade in position within the blade receptacle by a blade lock lever 42 (FIG. 3). The blade lock lever is released by a release mechanism 44 located on the outer surface of the main housing.

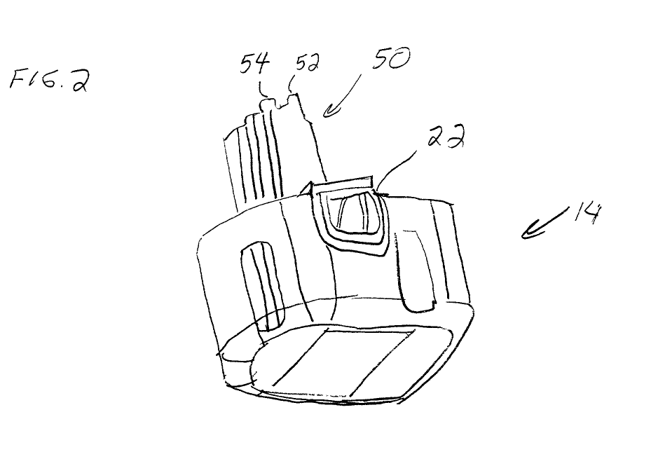

FIG. 2 is a side perspective view of the battery pack 14 removed from the main housing 12 in the preferred embodiment of the present invention. The battery pack is preferably shaped to include a projection element 50 having a first contact 52 and a second contact 54. The projection is inserted into the main housing 12 at a receiving chamber 56 located on one end of the main housing. The battery pack may be recharged by AC current from an electrical outlet. The construction and use of a rechargeable battery pack is well known by those skilled in the art of rechargeable power tools. The battery pack may be utilized to power other power tools. However, the battery pack is utilized in the preferred embodiment of this invention to power a DC 12 volt motor driving the movement of the blade 16.

FIG. 3 is a side cutaway view of an interior portion 60 of the main housing 12 of FIG. 1. The interior portion includes a 12 volt DC motor 62 driving a rotating shaft 64. The shaft 64 drives two reciprocating pistons 66 and 68. The blade 16 is attached to the pistons. The energy of the rotating shaft is translated by a gear assembly 67 to the reciprocating action of the pistons. The motor, shaft, gear assembly, and piston system is well known in electric knives. It must be understood that other systems may be utilized to drive the blade in a reciprocating motion. The motor includes two contacts 70 and 72 leading to an interior wall 74 adjacent the receiving chamber 56. When the battery pack 14 is installed within the receiving chamber, the battery pack's first and second contacts 52 and 54 are positioned adjacent the interior wall and the contacts 70 and 72, thus forming an electrical connection between the battery pack and the motor.

Still referring to FIG. 3, the blade is held in position within the blade receptacle 40 by the blade lock lever 42. To release the blade lock lever, the release mechanism is depressed.

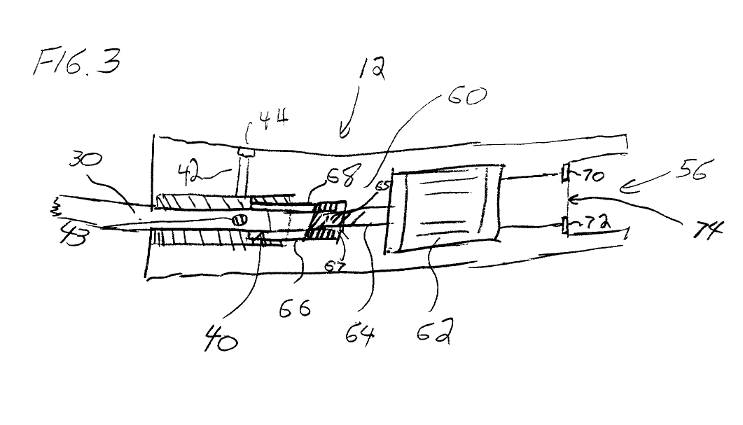

FIG. 4 illustrates a side view of the outer surface of the main housing 12 with the battery pack 14 inserted within the receiving chamber 56 in the preferred embodiment of the present invention. The outer surface may include a vent opening 80 providing an air flow to the interior portion 60 of the main housing.

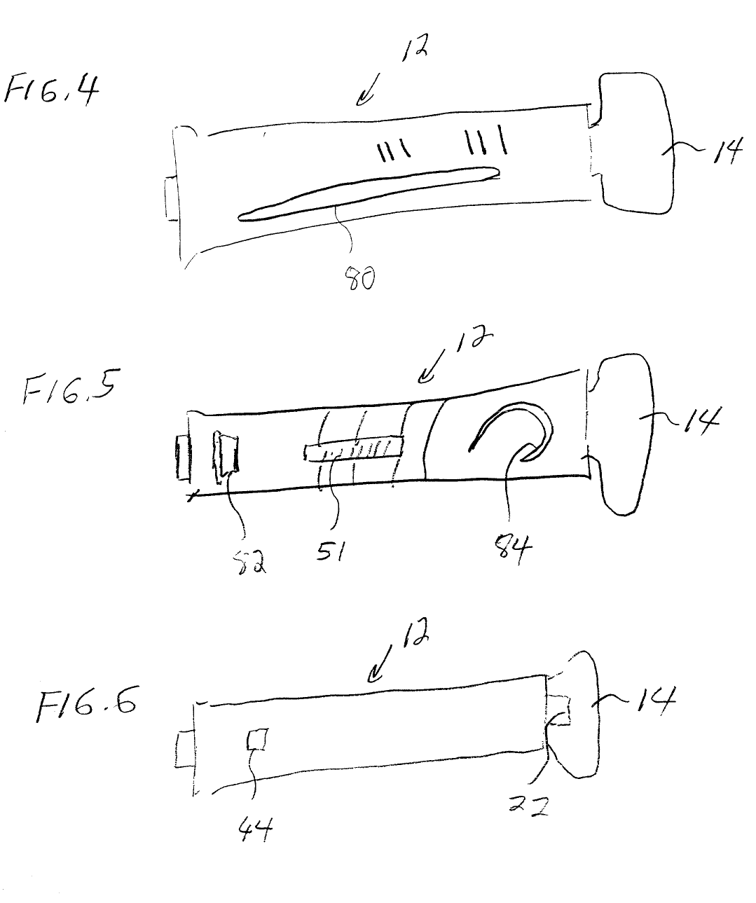

FIG. 5 is a bottom longitudinal view of the outer surface of the main housing 12 and battery pack 14 of FIG. 4. The main housing may include an optional bottle opening 82 and a twist top opener 84. The openers may be utilized to open beverage containers as desired by a knife operator.

FIG. 6 is a top longitudinal vie w of the outer surface of the main housing 12 and battery pack 14 of FIG. 4. As illustrated, the release mechanism is easily accessible by the knife operator.

Referring to FIGS. 1-6, the operation of the cordless knife 10 will now be explained. As discussed above, the knife 10 may hold one of a plurality of different sizes and shapes of blades 16, depending on the task to be performed. The selected blade is inserted within the blade receptacle 40 of the main housing 12. The blade is held in position by the blade lock lever 42. The blade lock lever is inserted into an opening 43 located on the shank section 30. The battery pack 14, prior to use of the knife, is charged at an AC electric power outlet. The battery pack is then inserted within the receiving chamber 56. The first and second contacts 50 and 52 located on the projection element 50 of the battery pack contact the motor contacts 70 and 72. An actuating trigger 51, located on the outer surface of the main housing is connected to the motor 62. When the trigger is depressed, the motor is actuated. Any device which allows the cordless knife to be activated and turned off may be utilized. The motor receives its power from the battery pack. Since the battery pack is a more robust power source providing power for a longer period of time than conventional electric cordless knives, the motor can drive a heavier blade.

Upon actuation by the trigger, the motor begins to rotate the rotating shaft 64. The rotating shaft includes a threaded rod 65 located at one end of the shaft. The threaded rod engages the gear assembly 67 translating the rotation of the rotating shaft to the reciprocating action of the pistons 66 and 68. The pistons drive forward and back, thus causing the blade 16 to move back and forth in a cutting motion. Although a gear assembly is discussed, it should be understood that any mechanism which allows the motor 62 to drive the blade 16 in a cutting motion may be used. Use of an electric motor to move a blade is well known in the art of cordless knives. In addition, although one blade 16 is illustrated, in an alternate embodiment of the present invention, more than one blade may be utilized. For example, a blade may be attached to each piston, or additional pistons may be used to drive the plurality of blades.

When the operator desires to stop cutting, he releases the trigger 51, thereby stopping the motor. The blade 16 may be removed, if desired, by pressing the release mechanism 44. The outer surface of the main housing 12 may also accommodate other devices, such as the conventional bottle opener 82 and the twist top opener 84, which may well be very useful by the knife operator during outdoor activities.

The cordless knife 10 provides many advantages over existing cordless knives. The knife 10 includes a rechargeable battery which may be used by other power tools. The battery is one of the costlier items associated with rechargeable power tools. Therefore, costs associated with utilizing a plurality of power tools can be reduced by employing an interchangeable battery. Additionally, with the use of an interchangeable battery, only one battery requires recharging. The battery pack also provides many advantages over batteries used in existing cordless knives. The existing cordless knives utilize a battery having limited duration and power available, while acceptable for kitchen use, is unacceptable for outdoor activities.

The cordless knife 10 also provides many advantages over existing rechargeable power tools. Although there are several types of power tools available, there has been no rechargeable power tool which may be used as a simple carving knife. All the existing cutting tools merely include a large cutting surface for use with heavy bulky yard activities, such as saws for cutting tree limbs. The cordless knife incorporates the interchangeable battery pack with a cordless knife for use by those individuals requiring a heavy-duty knife for fairly precise cutting, as required in fishing and hunting.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

What is claimed is:

1. A cordless knife for use in cutting, the knife comprising:
a main housing having a receiving chamber located on a first end of said main housing;
at least one blade positioned within a blade receptacle located at a second end opposite the first end of said main housing;
means for detachably retaining said blade within the blade receptacle;
means for driving said blade in a reciprocal cutting motion;
rechargeable power source capable of being interchanged with other power tools, said power source being positioned within the receiving chamber of said main housing; and
a trigger for actuating said driving means;
whereby depressing said trigger allows said rechargeable power source to power said driving means, said driving means driving said blade in a reciprocal cutting motion.

2. The cordless knife of claim 1 wherein said driving means is a DC motor.

3. The cordless knife of claim 2 wherein the DC motor is a 12 volt DC motor.

4. The cordless knife of claim 2 wherein said DC motor is located within an interior portion of said main housing, said motor having a plurality of motor contacts leading to an exterior wall of the receiving chamber.

5. The cordless knife of claim 4 wherein the power source is a detachable battery pack module having connecting means for retaining the battery pack module within the receiving chamber, said battery pack module capable of being attached to other power tools and provide power to the other power tools.

6. The cordless knife of claim 5 wherein the battery pack module includes a plurality of battery contacts positioned to contact said plurality of motor contacts when the battery pack module is positioned within the receiving chamber, providing an electric connection between the battery pack module and the motor.

7. The cordless knife of claim 1 wherein the power source is a detachable battery pack module having connecting means for retaining the battery pack module within the receiving chamber, said battery pack module capable of being attached to other power tools and provide power to the other power tools.

8. The cordless knife of claim 7 wherein the battery pack module is a 12 volt battery.

9. The cordless knife of claim 1 wherein the main housing includes means for opening a bottle.

10. The cordless knife of claim 1 wherein the means for retaining said blade is a retaining lever holding a portion of said blade within the blade receptacle.

11. The cordless knife of claim 1 wherein the driving means is a motor.

12. The cordless knife of claim 12 wherein the motor includes a driven rotating shaft which drives a plurality of pistons in a reciprocating motion.

13. The cordless knife of claim 1 wherein the blade is two blades driven by said driving means in a reciprocating cutting motion.

14. A cordless knife for use in cutting, the knife comprising:
a main housing having a receiving chamber located on a first end of said main housing;
at least one blade positioned within a blade receptacle located at a second end opposite the first end of said main housing;
retaining lever holding a portion of said blade within the blade receptacle;
a motor for driving said blade in a reciprocal cutting motion;
a rechargeable battery pack module capable of being interchanged with other power tools, said battery pack module being positioned within the receiving chamber of said main housing; and
a trigger for actuating said motor;
whereby depressing said trigger allows said battery pack module to power said motor, said motor driving said blade in a reciprocal cutting motion.
